(19) United States
(12) Patent Application Publication
(10) Pub. No.: US 2008/0080218 A1
(43) Pub. Date: Apr. 3, 2008

(54) BANDWIDTH AND OUTPUT IMPEDANCE CONTROL IN A POWER SUPPLY

(76) Inventors: Gunnar R. Holmquist, Santee, CA (US); Liyu Cao, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/562,843

(22) Filed: Nov. 22, 2006

Related U.S. Application Data
(60) Provisional application No. 60/854,768, filed on Oct. 27, 2006.
(60) Provisional application No. 60/848,090, filed on Sep. 28, 2006.

(51) Int. Cl. H02M 7/00

(52) U.S. Cl. 363/74

(57) ABSTRACT

A power supply includes a feedback loop allowing user control of bandwidth and output impedance. The feedback may combine both voltage feedback and current feedback. Control of power supply bandwidth and impedance allows legacy power supply emulation in automated test systems.

### CROSS REFERENCE TO RELATED APPLICATIONS

This application claims priority under 35 U.S.C. Section 119(e) to provisional application 60/848,090, entitled Power Supply Output Impedance Control By Combined Voltage and Current Feedback, filed on Sep. 28, 2006, and also claims priority under 35 U.S.C. Section 119(e) to provisional application 60/854,768, entitled Bandwidth and Output Impedance Control in a Power Supply, filed on Oct. 27, 2006.

### BACKGROUND OF THE INVENTION

1. Field of the Invention

The invention relates to output regulation of power supplies.

2. Description of the Related Art

Power supplies typically provide a voltage at a preset or programmed output level to a load impedance. Since the physical output impedance of a power supply is never zero, absent a compensating scheme, the output voltage of the power supply would experience a deviation from the desired value dependent on the impedance of the load. Feedback loops are typically employed to compensate for load-dependence of the output voltage such that a constant output voltage is maintained as the current sourced by the power supply changes.

Such a feedback loop is illustrated in FIG. 1. Power hardware 20 provides a voltage to a load Z_{L} at a power supply output 24. The output level is controlled by a reference input 26. A voltage sensor in the power hardware provides a signal related to the output voltage level which is subtracted from the reference signal. GAIN1 designated 28 is associated with this feedback. The output of the subtractor 30 is fed to the power hardware 20. An additional GAIN2 designated 32 may be associated with the signal path from the subtractor 30 to the power hardware. GAIN3 is associated with the power hardware 20 itself. The open loop gain of the system is the product of all gains in the loop. The closed loop gain, defined as the output level divided by the reference input, is 1/(GAIN1)*G_{O}/(1+G_{O}), where G_{O} is the open loop gain. For large open loop gain (e.g. GAIN1*GAIN2*GAIN3 much greater than 1), the closed loop gain is 1/(GAIN1).

All of the gains in this loop may have frequency dependence, with the gains typically falling off with increasing frequency. The frequency at which the open loop gain drops to 1 is referred to the crossover frequency. This frequency dependence is strongly influenced by the details of the power hardware design and components. Thus, power supplies with nominally identical outputs will actually have different responses to load changes due to different switching topology, output filtering, and the like. In a testing environment, these different responses can produce different test results, adversely affecting test uniformity.

### SUMMARY OF THE INVENTION

In one embodiment, the invention comprises a power supply comprising power hardware having an output configured for coupling to a load impedance, at least one feedback loop having user programmable gain wherein the bandwidth and/or output impedance of the power supply are user controllable via the user programmable gain.

In another embodiment, a power supply comprises power hardware having an output configured for coupling to a load impedance, an output voltage sensor, an output current sensor, an analog to digital converter coupled to the output voltage sensor configured to output a digital representation of power hardware output voltage, and an analog to digital converter coupled to the output current sensor configured to output a digital representation of power hardware output current. Also provided are current and voltage feedback loops configured to arithmetically combine one or more digital values derived from the digital representation of power hardware output current, one or more digital values derived from the digital representation of power hardware output voltage, and one or more digital values derived from a reference signal, wherein the feedback loops generate a control signal derived from the combination. The control signal is coupled to the power hardware and regulates one or more power hardware output parameters.

In another embodiment, a method of adjusting the output impedance of a programmable power supply comprises combining both voltage and current feedback with a reference signal to produce a control signal for regulating power supply output.

In another embodiment, a method of selecting a bandwidth for a programmable power supply having an output voltage feedback loop comprises digitally programming a frequency dependent gain into the voltage feedback, combining the voltage feedback with a reference signal to produce a control signal, and regulating power supply output with the control signal.

In another embodiment, a power supply comprises power hardware having an output configured for coupling to a load impedance and at least one interface configured to accept commands that define power supply output voltage characteristics, power supply output current characteristics, and power supply bandwidth characteristics.

In another embodiment a power supply comprises power hardware having an output configured for coupling to a load impedance, and at least one interface configured to accept commands that define power supply output voltage characteristics, power supply output current characteristics, and power supply output impedance characteristics.

In another embodiment, a method of configuring test equipment comprises digitally programming a power supply to have similar output impedance and/or bandwidth characteristics as a different power supply previously present in the test equipment.

### BRIEF DESCRIPTION OF THE DRAWINGS

FIG. 1 is a block diagram of a power supply feedback loop of the prior art.

FIG. 2 is a block diagram of a combined voltage and current feedback loop according to an embodiment of the invention.

FIG. 3 is another block diagram of a combined voltage and current feedback loop according to an embodiment of the invention.

FIG. 4 is an illustration of one possible functional dependence of current feedback on output current level.

FIG. 5A is a graph of current vs. time for different programmed bandwidths.

FIG. 5B is a graph of current vs. time for different programmed output impedance.

FIG. 6 is a block diagram of an automated test system in accordance with one embodiment of the invention.

### DETAILED DESCRIPTION OF THE PREFERRED EMBODIMENT

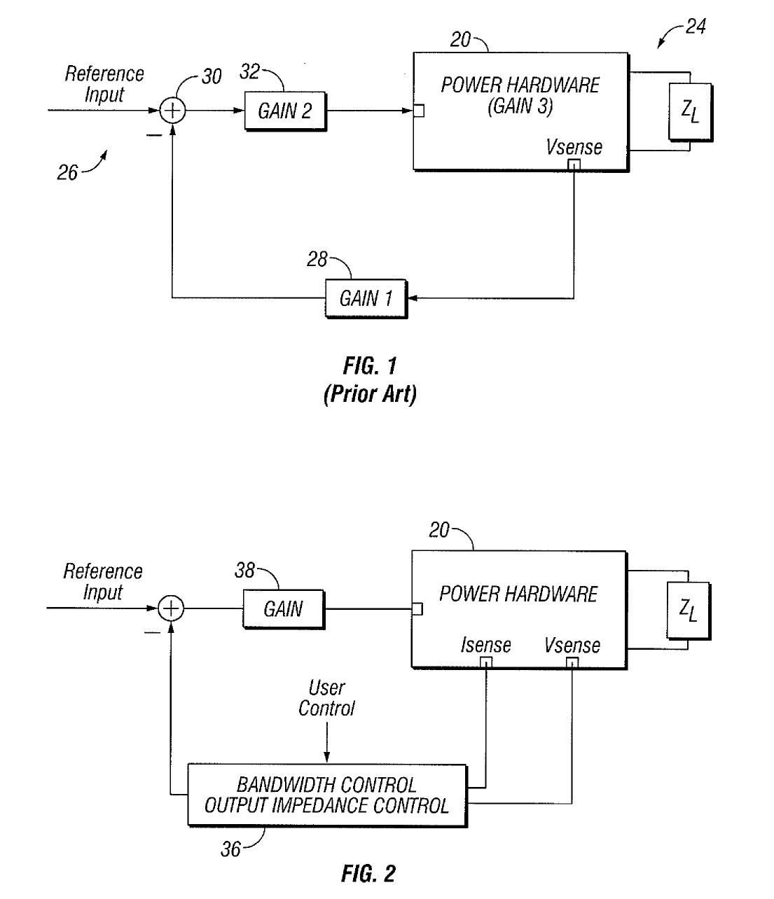

Using feedback loops such as described above, modern power supplies can regulate output voltage or current precisely. Output current regulation may be provided with a current feedback loop having a design similar to the voltage feedback loop above in FIG. 1. Conventionally, the current and voltage feedback loops are separate, and the power supply operates under the control of one or the other at a given time. A well-designed power supply can thus provide fixed and very accurate output voltage or output current under a wide range of load conditions. This means that, when regulating output voltage, the power supply's output impedance is extremely low, or very close to zero. This is a major advantage of the regulated power supplies. In addition, efforts are usually directed to making the power supply have the highest possible bandwidth within constraints related to production cost, complexity, etc. High bandwidth is typically desirable since higher bandwidth supplies can respond rapidly to rapid load changes. However, in some cases the user of a power supply may need to be able to control the output impedance or bandwidth, such as to vary the impedance as a function of the load. In such a case, the traditional voltage or current feedback configuration will not be able to meet the need.

In one embodiment of the invention, illustrated in FIG. 2, additional flexibility and user control is provided by including bandwidth and/or output impedance control 36 in the voltage and/or current feedback paths. As explained further below, in most advantageous embodiments, the bandwidth and output impedance are user controllable by allowing the user to program gain parameters into the feedback loop. In these embodiments, the power hardware 20 and error amplifier 38 are designed to provide near zero output impedance and high bandwidth response characteristics. If the user wishes to reduce the bandwidth or increase the output impedance of the power supply, gain parameters of the feedback loop may be appropriately programmed to produce the desire power supply output characteristics. In these embodiments, it is especially advantageous if the feedback loop is implemented digitally. Digital feedback loops for programmable voltage and current source power supplies are described in additional detail in U.S. patent application Ser. No. 11/541,439, entitled Power Supply with Digital Feedback Loop and U.S. patent application Ser. No. 11/540,938, entitled AC Output Power Supply with Digital Feedback Loop, both filed on Sep. 28, 2006 and incorporated by reference herein in their entireties.

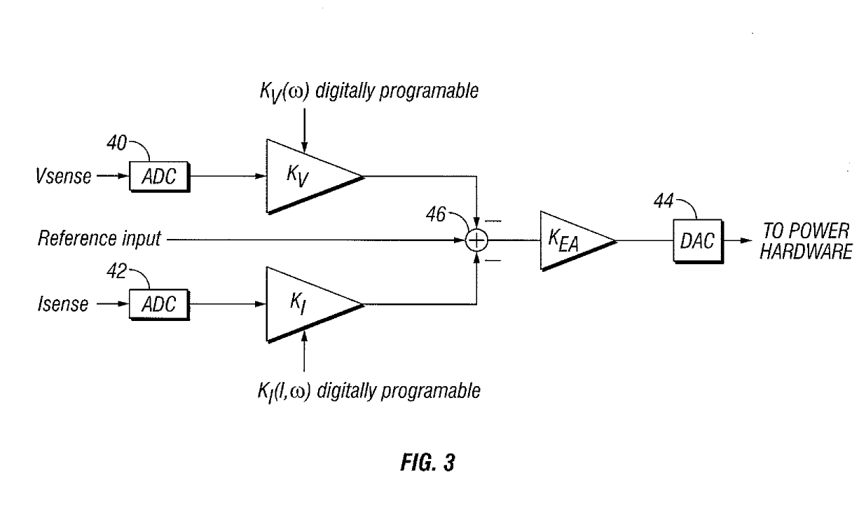

One embodiment of a digital feedback loop that can be used to programmably control bandwidth and/or output impedance is illustrated in FIG. 3. In this embodiment, the voltage and current feedback are combined in the same feedback loop. Conventionally, power supplies only use the voltage feedback when providing a controlled voltage to a load, it is not combined with the output current feedback. By adding current feedback to the voltage loop, the power supply gains an adjustable output impedance.

In the embodiment of FIG. 3, the output of the power supply voltage sensor is converted to a digital value by an analog to digital converter 40. The result is amplified by a scaling factor K_{V} which as will be explained further below, can have a frequency dependence in some embodiments. The output of the power supply current sensor is converted to a digital value by another analog to digital converter 42. This result is amplified by a scaling factor K_{I} which can be dependent on the output current value, and in some cases may have frequency dependence as well. The scaled voltage and current feedback values are subtracted from the reference input to produce the error output, which is then amplified by another factor K_{EA}. The resulting control signal is converted back to the analog domain by a digital to analog converter 44, the output of which is used to control the power hardware.

Assuming the open loop gain is very large (which is usually true), the error e at the adder 46 output is very close to zero:

e=V_{ref}−K_{V}Vₒᵤₜ−K_{I}Iₒᵤₜ=0

Then the voltage difference seen at the adder's input is

V_{ref}=K_{V}Vₒᵤₜ=K_{I}Iₒᵤₜ

At the supply's output the voltage difference is given by

$$\frac{{V}_{ref}}{{K}_{V}} - {V}_{out} = \frac{{K}_{I}}{{K}_{V}} {I}_{out}$$

Therefore, with the combined voltage and current feedback, the output voltage follows the equation

Vₒᵤₜ=V₀−RIₒᵤₜ

where V₀ and R are defined by

$${V}_{0} = \frac{{V}_{ref}}{{K}_{V}}$$

$$R = \frac{{K}_{I}}{{K}_{V}}$$

The above equations show that the power supply's output voltage is V₀ under no load, and its output impedance is R. The output impedance R can be adjusted by changing the current scaling factor K_{I}. With no current feedback, that is, K_{I}=0, R=0, the power supply is just a regulated voltage source with the fixed output voltage V₀.

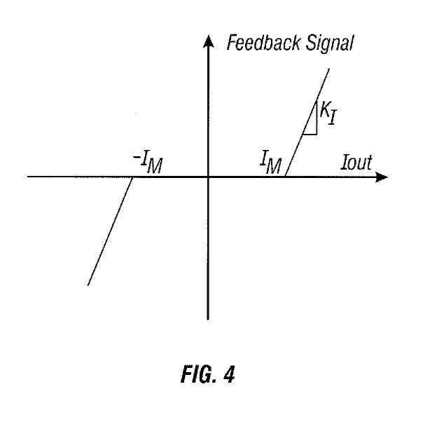

In a digital implementation, digitally programmable user control over the current feedback loop may be provided. In these embodiments, the current scaling factor K_{I} may be stored in a digital register, which can be programmed by the user. Programmability of this factor as a function of time or output current may be provided. Thus, the user can have a fixed output impedance or a variable output impedance as a function of the load. The function shown in FIG. 4 is an example of the peak current limiter used in AC power supplies. When the load current is less than the limit value I_{M}, the current feedback is not active and only the voltage loop is running. When the load current is beyond the current limit, impedance control becomes active and the peak current is limited by the current feedback scaling factor K_{I}. By implementing the function of FIG. 4 digitally and with the programmable limit level I_{M} and slope K_{I}, the same power supply can have multiple functions. By programming K_{I}=0, the power supply will behave just like a voltage source with standard voltage feedback. By programming I_{M}=0 with a non-zero K_{I}, the power supply will have a user programmable fixed output impedance. When both K_{I} and I_{M} are non-zero, then the power supply will have peak current control. Therefore, with digital implementation of the combined voltage and current feedback, a single power supply can have multiple configurations and serve the multiple needs of various users and environments.

Referring back to FIG. 3, by programming the voltage loop's bandwidth, the user can change the output impedance as a function of frequency, which may be a useful feature for AC power supplies. This can allow a power supply to emulate the behavior of other power supplies with regard to peak and RMS load currents. For some test applications, it can be desirable when changing out older power supplies that the new power supplies deliver the same peak and RMS currents to the units under test (UUT). In this way, the test results will be the same as those from the previously used power source.

This can be implemented by having the voltage feedback scaling factor K_{V} be programmable as a frequency dependent value. For example, pre-defined filter coefficients can be used that will produce a user programmed crossover frequency for the power supply. Upon receiving user input defining a crossover frequency, the power supply can compute or look up appropriate filter parameters to use to produce the user desired frequency dependence.

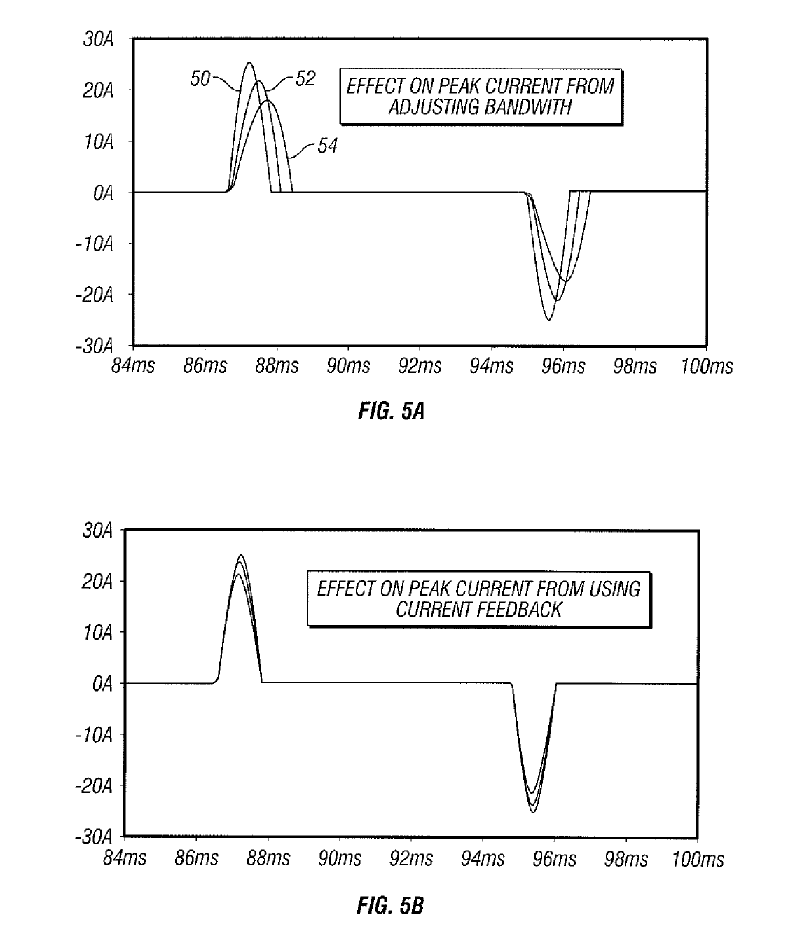

FIGS. 5A and 5B illustrate the way in which bandwidth, current feedback, and output impedance influence peak and RMS load currents. In these Figures, the same rectifier-capacitor load is coupled to a voltage regulated 60 HZ sine wave power supply output. The load is the same for all cases. However, it can be seen that by programming different bandwidth and/or output impedance, the currents are different. In general, the lower the bandwidth or higher the output impedance, the lower the peak and RMS currents.

FIG. 5A illustrate this relationship for crossover frequencies of 3 kHz (trace 54), 8 kHz (trace 52), and 25 kHz (trace 50). These traces were produced by setting K_{I}=0, and varying the frequency dependence of K_{V}.

Another way in which output impedance, and thus peak currents, can be controlled is by using the above described current feedback. FIG. 5B illustrates the change in peak and RMS currents due to a different non-zero values of K_{I} (with I_{M}=0). The peak currents drop with increasing K_{I}.

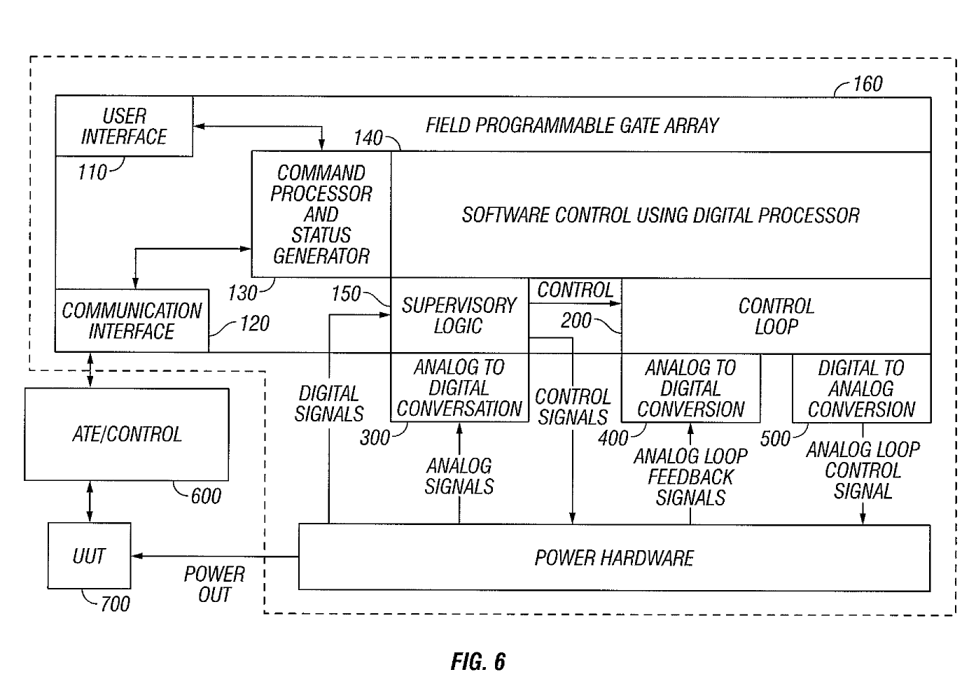

FIG. 6 illustrates a power supply having the above described programmability in a testing environment. The power supply comprises a power supply digital control 160 and power hardware 600. The power supply digital control 160 may include a user interface 110, a communication interface 120, a command processor/status generator 130, a digital processor for running control software, supervisory logic 150, and a control loop 200, which in one exemplary embodiment may be partly or wholly implemented in combinatorial and sequential logic, one example of which is a field programmable gate array. The power supply digital control further includes data converters. The data converters may include a first analog-to-digital converter (ADC) unit 300, a second ADC unit 400, and a digital-to-analog converter (DAC) unit 500.

The command processor/status generator 130 is connected to the user interface 110 and to the communication interface 120. The command processor/status generator 130 is connected to the digital processor 140 for software control. Both the supervisory logic 150 and the control loop 200 are connected to the digital processor 140. The first ADC unit 300 is connected to the supervisory logic 150, and the second ADC unit 400 and the DAC unit 500 are connected to the control loop 200.

The communication interface 120 communicates with an automated test system 600 that controls both the power supply and a unit under test 700. The above described gain functions and filter coefficients for control of impedance and bandwidth are implemented in the digital logic implementing the software control 140 and control loop 200.

Using the above described digital feedback control, an AC power source used, for example, in a testing application can have its bandwidth and output impedance set to match the originally used AC power source. This may require no hardware changes. At power on, the automated test system 600 can communicate information to the AC power source indicating what type of ATE system it is installed in. The power source can use this information to look up or otherwise define the desired output impedance characteristics and crossover frequency it should be operating with, and configure its control loop to match those requirements. It has been found that test results in some testing applications are very sensitive to power supply output characteristics, and it can be difficult to perform highly desirable upgrades to power supply components due to the effect the new supplies have on test performance. The ability to programmably emulate legacy power supply equipment is especially advantageous in these situations.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A power supply comprising:
power hardware having an output configured for coupling to a load impedance;
at least one feedback loop having user programmable gain wherein bandwidth and/or output impedance of said power supply are user controllable via said user programmable gain.

2. The power supply of claim 1 comprising a voltage feedback path and a current feedback path.

3. The power supply of claim 2, wherein the gain of the voltage feedback path is frequency dependent.

4. The power supply of claim 2, wherein the gain of the current feedback path is output current dependent.

5. The power supply of claim 1, wherein said feedback loop is implemented digitally.

6. The power supply of claim 1, comprising a communication interface for programming a desired output parameter.

7. The power supply of claim 1, wherein said output parameter comprises output voltage.

8. The power supply of claim 1, wherein said output parameter comprises output current.

9. The power supply of claim 1, wherein said output parameter comprises loop gain crossover frequency.

10. The power supply of claim 1, wherein said output parameter comprises output impedance.

11. The power supply of claim 1, wherein said power supply is configured to provide an AC output voltage to said load.

12. The power supply of claim 1, wherein said power supply is configured to provide an DC output voltage to said load.

13. A power supply comprising:
power hardware having an output configured for coupling to a load impedance;
an output voltage sensor;
an output current sensor;
an analog to digital converter coupled to said output voltage sensor configured to output a digital representation of power hardware output voltage;
an analog to digital converter coupled to said output current sensor configured to output a digital representation of power hardware output current;
current and voltage feedback loops configured to arithmetically combine one or more digital values derived from said digital representation of power hardware output current, one or more digital values derived from said digital representation of power hardware output voltage, and one or more digital values derived from a reference signal, wherein said feedback loops generate a control signal derived from said combination, and wherein said control signal is coupled to said power hardware and regulates one or more power hardware output parameters.

14. A method of adjusting the output impedance of a programmable power supply, said method comprising combining both voltage and current feedback with a reference signal to produce a control signal for regulating power supply output.

15. The method of claim 14, comprising:
generating digital representations of output voltage and output current; and
processing and combining said representations and said reference signal in the digital domain to generate said control signal.

16. The method of claim 14, wherein said current feedback comprises a digitally programmable gain.

17. A method of selecting a bandwidth for a programmable power supply having an output voltage feedback loop, said method comprising:
digitally programming a frequency dependent gain into said voltage feedback; and
combining said voltage feedback with a reference signal to produce a control signal; and
regulating power supply output with said control signal.

18. The method of claim 17, additionally comprising combining current feedback with said reference signal, wherein said current feedback comprises a digitally programmable gain.

19. A power supply comprising:
power hardware having an output configured for coupling to a load impedance;
at least one interface configured to accept commands that define power supply output voltage characteristics, power supply output current characteristics, and power supply bandwidth characteristics.

20. A power supply comprising:
power hardware having an output configured for coupling to a load impedance;
at least one interface configured to accept commands that define power supply output voltage characteristics, power supply output current characteristics, and power supply output impedance characteristics.

21. A method of configuring test equipment comprising digitally programming a power supply to have similar output impedance and/or bandwidth characteristics as a different power supply previously present in said test equipment.
